(19) United States
(12) Patent Application Publication
(10) Pub. No.: US 2024/0067370 A1
(43) Pub. Date: Feb. 29, 2024

(54) DRONE SYSTEM HAVING INTERACTIVE FETCHABLE DRONE

(71) Applicant: Michael G. Hamouz, Streamwood, IL (US)

(72) Inventor: Michael G. Hamouz, Streamwood, IL (US)

(21) Appl. No.: 17/889,316

(22) Filed: Aug. 16, 2022

Related U.S. Application Data
(60) Provisional application No. 63/234,364, filed on Aug. 18, 2021.

(51) Int. Cl. B64U 50/14; G05D 1/00; H04R 1/02; H04R 3/00

(52) U.S. Cl. CPC B64U 50/14; G05D 1/0016; G05D 1/0044; H04R 1/028; H04R 3/00; B64U 2101/30

(57) ABSTRACT

This invention relates generally to pet and child toys and drones. More specifically, the invention relates to an apparatus and method of operation for an autonomous or remotely controlled fetch toy drone for pets and children that is safe to operate and retrieve, extends the fetching range beyond that of a throw-type fetch toy, and also provides numerous other features, such as actuated shut-down and audio broadcast features, as well as video and audio recording capabilities, and supplemental stimuli features.

### CROSS REFERENCE TO RELATED APPLICATIONS

This non-provisional patent application claims priority to U.S. Provisional Patent Application Ser. No. 63/234,364 having a filing date of Aug. 17, 2021, which is fully incorporated by reference herein.

### TECHNICAL FIELD OF THE INVENTION

This invention relates generally to pet and child toys and drones. More specifically, the invention relates to a system and method of operation for an autonomous or remotely controlled fetch toy drone for pets and children that is safe to operate and retrieve, extends the fetching range beyond that of a throw-type fetch-toy, and provides numerous other features, such as actuated shut-down and audio broadcast features, video and audio recording capabilities, and supplemental stimuli features.

### BACKGROUND OF THE INVENTION

Pets, and particularly dogs, often love to play fetch with their owners. Throwing an object such as a ball or stick for a dog, however, can get tiring, and the distance the dog runs to fetch the object is generally limited to the distance that the pet owner can throw. An aerial drone used as the object, however, can extend the range that the dog travels to fetch the object, but typical aerial drones are fragile and may break in the grip of a dog's mouth. Furthermore, spinning propellers propelling a typical aerial drone may easily injure the dog as it attempts to fetch the object or otherwise grasp it in its mouth.

Also, it is often fun to watch video of the dog chasing, and grasping the object and running back to the owner, but mounting a camera and microphone on the dog results in a shaky image at best. Furthermore, dogs also can lose interest in the game after only a few throws. However, if a supplemental stimuli feature is provided by the drone, such as a releasable or ejectable treat or toy, dogs will rarely lose interest in the game since the supplemental stimuli is associated with the retrieval of the object. The use of an audio generator and predetermined sounds that broadcast sounds from the drone, such as the sounds of animals, squeak toys, shouts of praise, or any other sound chosen by the user, when actuated by the system's operator or dog's bite or grip of the drone, further prevents the dog from losing interest in the game.

Therefore, there is a need for a drone-fetch system that can extend the range that the dog travels to fetch the object. The system would allow the dog to safely grasp the drone without injury and without breaking the drone itself. The drone of the system would provide a video camera with a microphone so that the dog's grasping of the drone and subsequent return trip would be captured with both video and audio. Moreover, the drone would provide a speaker that broadcasts predetermined/user inputted sounds when actuated by the operator or when the drone is gripped by the dog. Still further, the drone would provide for supplemental stimuli, such as the release or ejection of a treat or toy to the dog upon reaching the object, giving the dog additional incentive to continue play. The present invention accomplishes these objectives.

### SUMMARY OF THE INVENTION

This invention relates generally to pet and child toys and drones. More specifically, the invention relates to a system for an autonomous or remotely controlled fetch toy drone for pets and children that is safe to operate and retrieve, extends the fetching range beyond that of a throw-type fetch-toy, and provides numerous other features, such as actuated shut-down and sound broadcast features, video and audio recording capabilities, and supplemental stimuli features.

The present invention is an aerial drone system for fetch or retrieval by a person, such as a child, or a pet, such as a dog. While it is understood that the any animal, to include humans, may fetch or retrieve the drone, a dog is described herein by way of example only. Typically, the aerial drone system is used in an open space where the dog has room to run and fetch. The aerial drone comprises a drone enclosure having at least an upper side, a lower side, and optionally a first end, and a second end, all of which define an internal volume within the drone enclosure. The drone further comprises at least one propeller driven by a motor and enshrouded by a protective cage. In a preferred embodiment, the optional first and second ends each have one or more propeller cages enshrouding a motor fixed with a propeller, such that air can flow between an upper side of the propeller cage and through to a lower side of the propeller cage.

A control circuit is substantially housed within the drone enclosure and has at least a power source, such as a rechargeable battery, a CPU, a memory, at least one orientation sensor, at least one proximity switch, accelerometer or pressure switch, and a wireless communication module in electrical communication with one another. The control circuit is in electrical communication with the motor of the at least one propeller to control the motor speed and direction. The control circuit deactivates the motors upon actuation of the at least one proximity switch, accelerometer, or pressure switch.

A wireless remote control is adapted to communicate commands to the wireless communication module of the control circuit of the aerial drone and receive data therefrom. In some embodiments, the wireless remote control includes a wireless remote control enclosure defining an internal volume for housing a remote control circuit that includes a power source, a CPU, a memory, a wireless communication module, an antenna, a video screen, a microphone and one or more user interfaces in electrical communication with one another, all of which are each adapted to transmit commands to the aerial drone.

Alternate embodiments of the system use a smart-phone as the wireless remote control, the smart-phone being of the type that has at least an enclosure, a battery, a CPU, a memory, a touch display screen, at least one speaker, microphone, audio signal generator, and a wireless communication module in electrical communication with one another. A software application is adapted to be executed on the smart-phone, the software application programmed to send the commands to the aerial drone and receive data from the drone.

In embodiments of the system having the at least one camera and one or more microphones located on the drone, the software application is adapted to further receive and display the video images and other data received from the drone on the smart-phone's touch display screen and receive and to play the audio from the aerial drone on the smart-phone's at least one speaker. Other, non-smart-phone wireless remote control units may incorporate an audio generator for generating at least one audio signal to the drone, video screens and the at least one audio speaker for the same reason. The software application is further adapted to utilize the audio generator to send at least one audio signal from the remote controller to an audio circuit and speaker on the drone, or to facilitate the broadcast of at least one sound from the drone's speaker.

As such, the wireless remote control is used to command the aerial drone to fly to a destination and land, and when retrieved by the dog, the at least one proximity switch, tube stop, pressure switch, propeller stop extension, propeller brake or accelerometer is actuated, and the motors are deactivated by the control circuit. In preferred embodiments, the proximity switch includes a wireless RFID tag reader that determines if an associated RFID tag worn by the dog is within a predetermined distance, whereupon the proximity switch is actuated to deactivate the motors.

In alternate embodiments, one or more pressure switches are each disposed along the drone enclosure, such that grasping the drone enclosure actuates one of the mechanical switches to actuate the proximity switch. In alternate embodiments, each propeller cage includes a propeller stop extension, such that when the upper and lower sides of the enclosure and/or propeller cage are pressed towards each other, the propeller stop extensions exerts pressure on the propeller and thereby the motor, increasing the resistance of the motor above a predetermined level to actuate the proximity switch, the control circuit thereafter deactivating the motors either until the pressure on the propeller is released, or after a predetermined restart delay time is reached.

In a further embodiment, each propeller cage includes at least one tube stop, such that when the upper and lower sides of the enclosure and/or propeller cage are pressed towards each other, the enclosure and/or propeller cage exerts pressure on a compressible tubular ring disposed circumferentially about the outer ends of the propeller blades such that the ring expands inwardly towards the propeller blades, when compressed between the upper and lower sides of the enclosure and/or propeller cage, thereby contacting the propeller blade ends and increasing the resistance of the motor above a predetermined level to actuate the proximity switch, the control circuit thereafter deactivating the motors either until the pressure on the propeller is released, or after a predetermined restart delay time is reached.

In an additional embodiment, each propeller cage includes at least one propeller brake operably engageable with the propeller and enclosure and/or cage. The brake includes pads preferably comprising compressible upper and lower brake pads, such that when the upper and lower sides of the enclosure and/or propeller cage are pressed towards each other, the enclosure and/or propeller cage transmits the pressure to the brake pads. The propeller preferably includes a blade ring and a ring extension at the outer ends of the propeller blades. When compressed between the upper and lower sides of the enclosure and/or propeller cage, the brake pads expand inwardly towards the brake ring and move downwardly towards the extension from a location displaced from the blade ring and extension, thereby contacting the propeller ring and extension and increasing the resistance of the motor above a predetermined level to actuate the proximity switch, the control circuit, thereafter deactivating the at least one motor either until the pressure of the ring and sheath on the propeller is released, or after a predetermined restart delay time is reached.

Preferably the one or more cameras are located on the drone, at least two of which have opposing fields of view. One or more microphones are located on the drone as well, whereby audio recorded from proximal to the drone enclosure and video images recorded by the at least one camera are stored by the control circuit in the memory, as well as being sent wirelessly to the wireless remote control through the wireless communication module.

In some embodiments, the drone system includes a supplemental stimuli feature whereby the drone enclosure includes a recess or connector adapted for containing or holding a treat or toy. The recess may include a cover that opens in concert with an electronic actuator connected with the control circuit, such that the treat or toy is prevented from falling away from the aerial drone until the control circuit activates the electronic actuator to allow the cover to open, releasing the treat or toy. The connector may similarly include a release that opens in concert with the electronic actuator connected with the control circuit, such that the treat or toy is prevented from falling away from the aerial drone until the control circuit activates the electronic actuator to allow the release to open, releasing the treat or toy. Other embodiments utilize a spring-biased “ejector” with the recess or release for forcibly ejecting the treat or toy from the drone.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of an aerial drone system in use with, for example, a dog;

FIG. 2 is an enlarged perspective view of one embodiment of the aerial drone of the present invention;

FIG. 3 is an enlarged perspective view of another embodiment of the propeller and motor configuration of aerial drone of FIG. 2;

FIG. 4 is an enlarged perspective view of yet another embodiment of the aerial drone of the present invention;

FIG. 5 is a top plan view of FIG. 4;

FIG. 6 is a cross-sectional view thereof, taken along line 6-6 of FIG. 5;

FIG. 7 is an alternate embodiment of the propeller cage and propeller stop of the embodiment of FIG. 6, as disclosed with a portion of the enclosure;

FIG. 8. is a further embodiment of the propeller cage and propeller stop of the embodiment of FIG. 6, as disclosed with a portion of the enclosure;

FIG. 9 is a system diagram of the invention, showing system components of the aerial drone, a wireless remote control, and a wireless smart-phone remote control.

### DESCRIPTION OF THE EMBODIMENTS

This invention relates generally to pet and child toys and drones. More specifically, the invention relates to a system for an autonomous or remotely controlled fetch-toy drone for a pets and children that is safe to operate and retrieve, extends the fetching range beyond that of a general fetch-toy, and also provides numerous other features, such as sound broadcast, video and audio recording capabilities, and supplemental stimuli features.

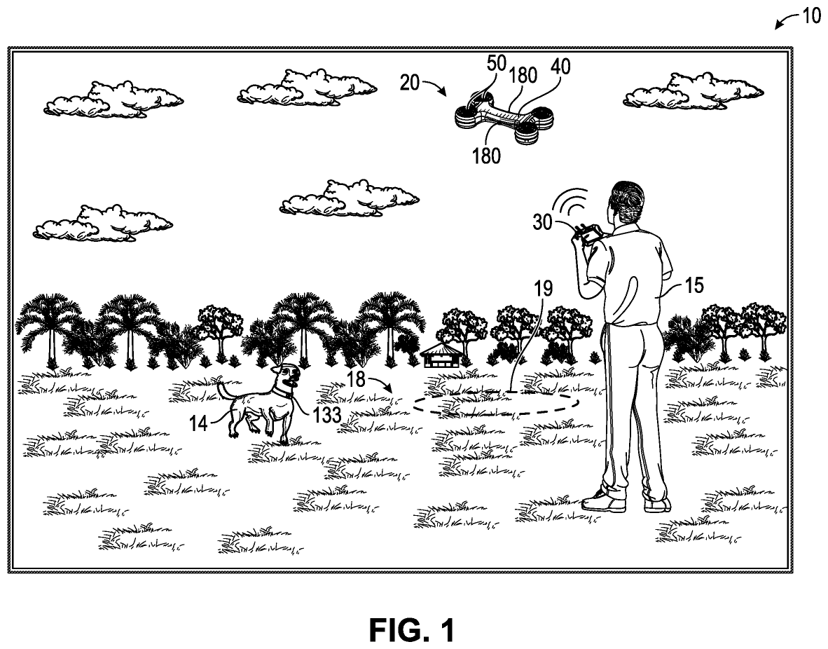

FIG. 1 illustrates one embodiment of an aerial drone system 10 for use with, for example, a pet 14, such as a dog. Typically, the aerial drone system 10 is used in an open space, either indoors or outdoors, where the pet 14 has room to run and fetch. The aerial drone system 10 preferably comprises at least an aerial drone 20 and a wireless remote-control unit 30 operated by a person 15 and in wireless communication with the drone. The wireless communication between the drone 20 and remote-control unit 30 comprises radio waves as understood in the art.

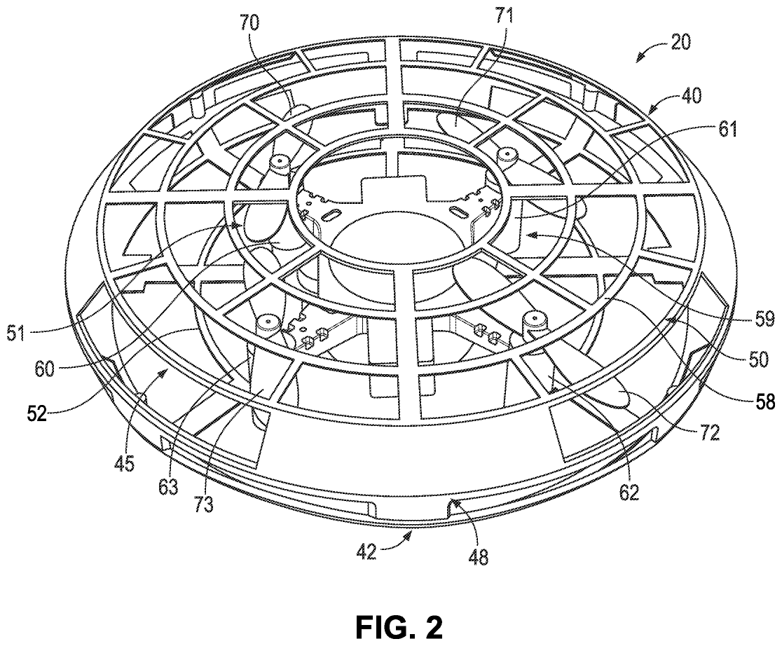

Referring to FIG. 2, in a first embodiment, the aerial drone 20 comprises a drone enclosure 40 having at least upper and lower sides 48 and 42, which define an internal volume 45 within the drone enclosure. The drone 20 further comprises at least one propeller 51 driven by at least one motor 59 and enshrouded by a protective cage 50 such that air can flow between an upper side 58 of the propeller cage and through to a lower side 52 of the propeller cage. In the embodiment illustrated in FIG. 2, the at least one propeller 51 comprises four propellers 70, 71, 72 and 73 within the drone enclosure 40, with the enclosure preferably defining the shape of a round disc oriented about parallel with the propellers. The propellers 70, 71, 72 and 73 of the at least one propeller 51 are driven by respective motors 60, 61, 62 and 63 of the at least one motor 59.

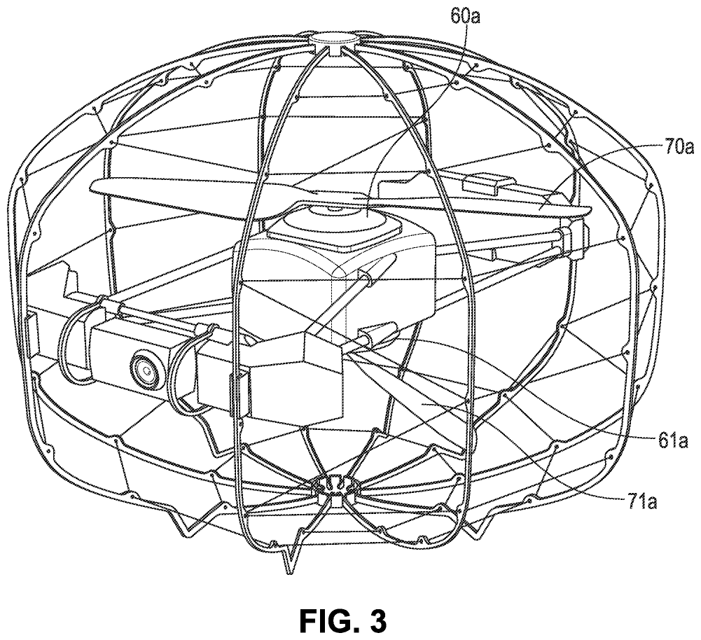

In the embodiment of FIG. 2, the enclosure 40 and protective cage 50 are one-in-the-same such that the enclosure 40 defines a round, disc shaped cage that enshrouds the remaining components of the drone 20, to include each of the propellers 70, 71, 72 and 73. Although FIG. 2 illustrates four propellers 70, 71, 72 and 73 respectively driven by the four motors 60, 61, 62 and 63, it is understood that other propeller/motor configurations are possible as well. For example, as illustrated in FIG. 3, the four propellers and motors are replaced by a pair of coaxial, counter-rotating propellers 70a and 71a respectively driven by motors 60a and 61a. Regardless of configuration, the drone enclosure 40 and cage 50, be they separate components or one-in-the-same, are ruggedized to withstand grasping by a dog's mouth and perhaps rough handling by a child. As such, the enclosure 40 and cage 50 are each preferably comprised of plastic materials understood in the art as providing durability.

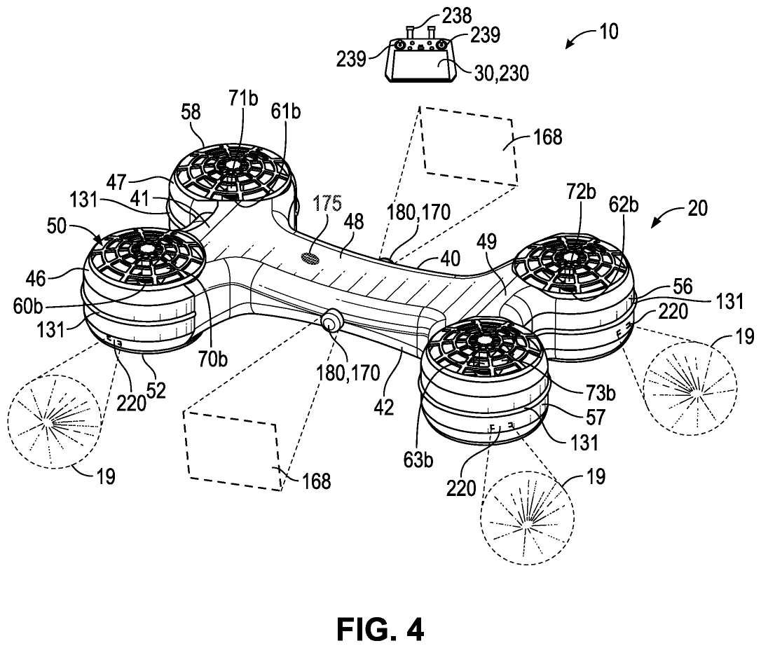

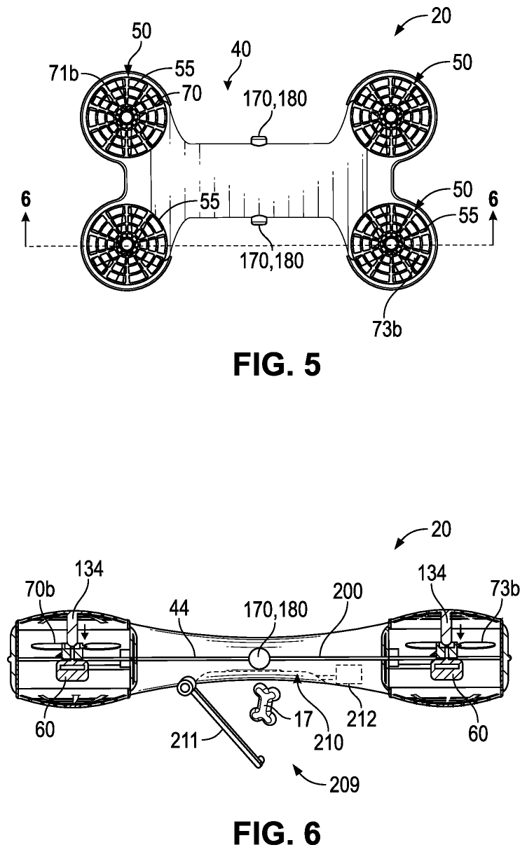

FIGS. 4-6 illustrate another embodiment of the drone 20. In keeping with the drone's use as a fetch toy for dogs, the enclosure 40 preferably defines a “cartoonesque” bone shape, with first and second ends 41 and 49 each defining the exaggerated appearance of a common bone end (i.e., the epiphysis of a bone) comprising a pair of rounded protrusions 46 and 47, and 56 and 57. Each pair of protrusions preferably house a respective pair of propeller cages 50 enshrouding an associated pair of propellers 70b and 71b, and 72b and 73b, respectively, driven by associated motors 60b and 61b, and 62b and 63b.

Preferably the bone-shaped drone enclosure 40 includes an elastomeric gasket 200 located within a seam 44 (FIG. 6), defined between the enclosure's upper and lower sides 48 and 42, to prohibit or resist liquids from entering the enclosure's internal volume 45. The motors 60b, 61b, 62b and 63b are each also preferably water-tight or resistant to prevent or minimize the occurrence of water-induced electrical failure. Further, the drone enclosure 40 and propeller cages 50 are again ruggedized to withstand grasping by a dog's mouth and perhaps rough treatment by a child.

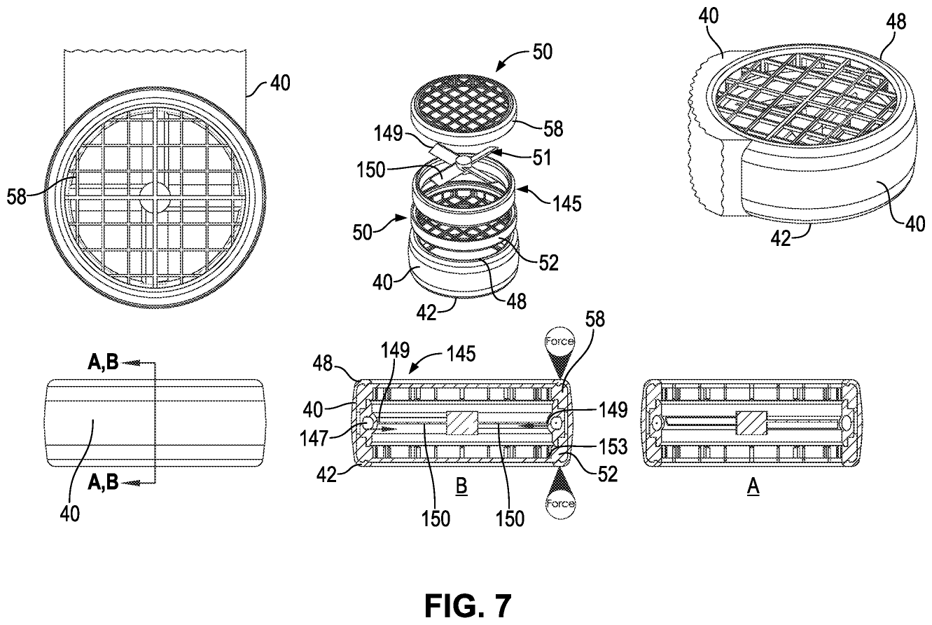

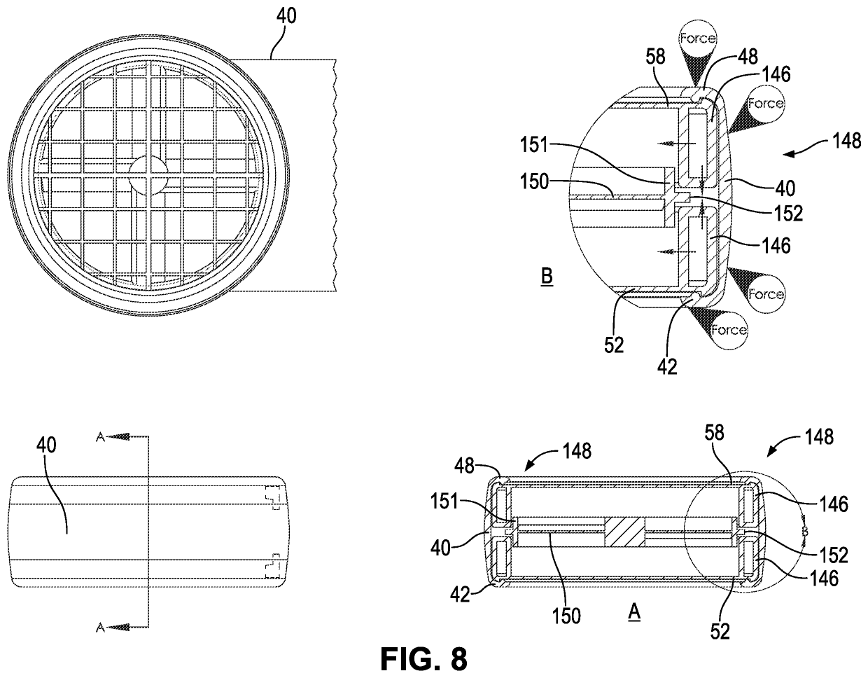

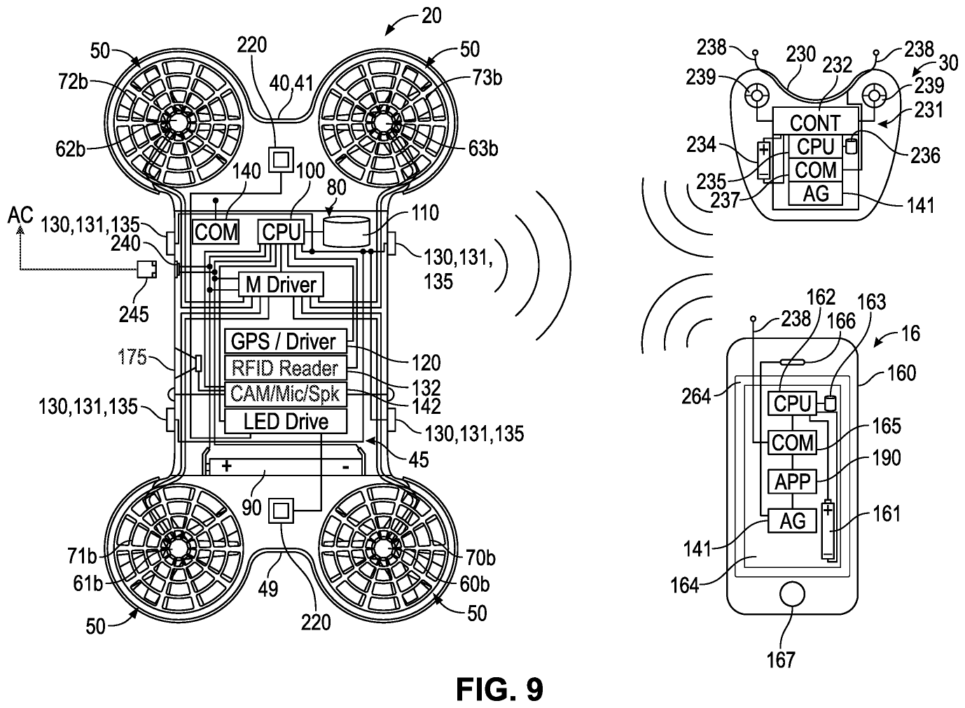

Referring to FIG. 9, a control circuit 80, preferably housed within the drone enclosure 40, comprises at least a power source, such as a rechargeable battery 90, a CPU 100, a memory 110, at least one orientation sensor (i.e., GPS Driver) 120, at least one proximity switch 130, pressure switch 131 and/or accelerometer 135, and a wireless communication module 140 in electrical communication with one another. The control circuit 80 is also in electrical communication with each of motors 60b, 61b, 62b and 63b to control motor speed and direction. The control circuit 80 also deactivates the motors 60b, 61b, 62b and 63b upon actuation of the at least one proximity switch 130, pressure switch 131, accelerometer 135, tube stop 145 (FIG. 7), stop extension 134 (FIG. 6), and/or propeller brake 148 (FIG. 8). The rechargeable battery 90 is preferably connectable to a recharging port 240 that connects with an AC adapter 245 or the like for charging or removed to be charged independently.

With further regard to deactivating the motors 60b, 61b, 62b and 63b via the at least one proximity switch 130, the switch, in one embodiment, includes a wireless RFID (Radio Frequency Identification) tag reader 132 that determines whether or not an associated RFID tag 133 (worn by the pet 14; FIG. 1) is within a predetermined or pre-programmed distance, such as five feet. If the RFID tag 133 is within this distance with the tag reader 132, the proximity switch 130 is actuated to deactivate the motors 60b, 61b, 62b and 63b. A deactivation of the motors thus causes the drone 20 to either make a controlled landing, or simply drop to the ground, thus allowing the dog to fetch or otherwise pick up the now-deactivated drone.

In alternate embodiments, if the RFID tag 133 is within the predetermined or pre-programmed distance with the tag reader 132, the proximity switch 130 is actuated to cause the drone 20 to “hover-in-place” at a predetermined vertical distance from the ground such that the dog can jump and grab the drone out of the air. To cease the operation of the motors 60b, 61b, 62b and 63b after the drone is grabbed by the dog, the one or more pressure switches 131 are disposed along the drone enclosure 40 such that grasping the drone enclosure actuates the pressure switches to deactivate the motors and associated propellers 70b, 71b, 72b and 73b. The one or more pressure switches 131 (FIG. 4) are preferably disposed between the upper and lower sides 48 and 42 of the drone enclosure 40 such that, when the upper and lower sides of the enclosure 40 or propeller cage 50 are pressed towards each other (i.e., by the gripping jaws of the dog), the motors 60b, 61b, 62b and 63b and associated propellers 70b, 71b, 72b and 73b are deactivated. In such embodiments, a spring or resilient member (not shown) biases the upper side 48 of the drone enclosure 40 and the lower side 42 of the drone enclosure 40 away from one other.

In a further embodiment of the system 10 utilizing an accelerometer 135 mounted on or within the drone enclosure 40, the accelerometer detects sudden increases or decreases in the drone's velocity, which generally exceed that produced by the drone's motor-driven propellers 70b, 71b, 72b and 73b, to deactivate the motors 60b, 61b, 62b and 63b. For example, when a dog grabs the drone 20, the associated sudden movements will cause a sudden increase or decrease in the drone's velocity (i.e., a sudden acceleration or deceleration) exceeding the acceleration and deceleration capability of the motor-driven propellers; with this sudden acceleration or deceleration detected by the accelerometer 135 and causing the motors to deactivate.

As illustrated in FIG. 4, yet additional embodiments comprise at least one propeller stop extension 134 defined on each cage 50 such that, when the upper and lower sides of the propeller cage 50 and/or drone enclosure 40 are pressed towards each other, one or more of the propeller stop extensions exerts axial pressure on one or more of the respective propellers 70b, 71b, 72b and 73b, or otherwise interfere with the propeller(s) rotation, and thereby one or more of the motors 60b, 61b, 62b and 63b, increasing the resistance of the motor(s) above a predetermined level to actuate the proximity switch 130; with the control circuit 80 thereafter deactivating the motors either until the pressure or interference on the propellers is released, or after the predetermined restart delay time is reached.

In such embodiments, a spring or resilient member (not shown) urges the upper and lower sides of the propeller cage 50 and/or enclosure away from each other. In other embodiments, the cages 50 themselves are comprised of a resilient, flexible material that allows the cage to compress inwardly towards the propeller under the compressive force of a grasping pet, and thereafter expand outwardly again to its original shape and position such that the at least one propeller stop extension 134 is axially moved into and out of resistance or interference with the at least one propeller. With further regard to the propeller cage 50, the upper and lower sides of the cage may optionally include a mesh 55 adapted to allow air flow there-through while preventing the person 15 or pet 14 from contacting the at least one propeller 51. The mesh 55 may be a separate screen type material attached to the cage 50, or manufactured unitary with the cage itself.

In a further embodiment illustrated in FIG. 7 (motor not illustrated for clarity), each propeller cage 50 includes at least one tube stop 145 operably engageable with the propeller 51 and enclosure 40 and/or cage 50, such that when the upper and lower sides 48 and 42 of the enclosure 40 and/or the upper and lower sides 58 and 52 of the propeller cage 50 are pressed towards each other, the enclosure and/or propeller cage transmits the pressure on a compressible tube 147 disposed within a sheath 153 circumferentially about the outer ends 149 of the propeller blades 150. The sheath 153 and tube 147 are preferably comprised of a flexible elastomeric material, such as a rubber or plastic. When compressed between the upper and lower sides of the enclosure 40 and/or propeller cage 50, the sheath 148 and tube 147 expands inwardly from a location displaced from the propeller blades (FIG. 7A) and inwardly towards the propeller blades 150, thereby contacting the propeller blade ends 49 (FIG. 7B) and increasing the resistance of the motor above a predetermined level to actuate the proximity switch 130, the control circuit 80 thereafter deactivating the at least one 59 motors either until the pressure of the ring and sheath on the propeller is released, or after a predetermined restart delay time is reached. Although the tube stop is disclosed with the embodiments of the drone system 10 and aerial drone 20 claimed herein, it is understood that the tube stop and associated components is readily adapted to any aerial drone and/or drone system.

In an additional embodiment illustrated in FIG. 8 (motor not illustrated for clarity), each propeller cage 50 includes at least one propeller brake 148 comprising brake pads 146 operably engageable with a propeller ring 147 and enclosure 40 and/or cage 50. The pads 146 preferably comprise compressible upper and lower brake pads, such that when the upper and lower sides 48 and 42 of the enclosure 40 and/or the upper and lower sides 58 and 52 of the propeller cage 50 are pressed towards each other, the enclosure and/or propeller cage transmits the pressure to the brake pads. The pads 146 are preferably comprised of a flexible elastomeric material, such as a rubber or plastic and may be unitary with the cage 50 or bonded thereto. The propeller includes a blade ring 151 and a ring extension 152 at the outer ends 149 of the propeller blades 150, preferably unitary with the propeller 51. When compressed between the upper and lower sides of the enclosure 40 and/or propeller cage 50, the brake pads 146 expand inwardly towards the brake ring 151 and move downwardly towards the extension 152 from a location displaced from the blade ring and extension, thereby contacting the propeller ring and extension and increasing the resistance of the motor above a predetermined level to actuate the proximity switch 130, the control circuit 80 thereafter deactivating the at least one 59 motors either until the pressure of the ring and extension of the propeller is released, or after a predetermined restart delay time is reached. Although the propeller brake is disclosed with the embodiments of the drone system 10 and aerial drone 20 claimed herein, it is understood that the brake and associated components is readily adapted to any aerial drone and/or drone system.

In an alternate embodiment, the proximity switch 130 includes one or more conductors (not shown) that are connected to the control circuit 80 to detect the proximity of the person 15 or the pet 14 through capacitance sensing, as is known in the art. As such, when the person 15 or the pet 14 is near enough to one or more of the conductors to cause a predetermined capacitance threshold to be exceeded, the proximity switch 130 is actuated to again shut-off power to the motors.

As introduced earlier in FIGS. 1 and 9, a wireless remote control 30 of the system 10 is adapted to communicate commands to the wireless communication module 140 of the control circuit 80 of the aerial drone 20. The commands include at least commands for the aerial drone 20 to rise, lower, move forward, move backward, turn left, turn right, turn on, and turn off. The wireless communication module 140 and the wireless remote control 30 each preferably utilizes a Wi-Fi wireless protocol, but can use other suitable wireless protocols, including cell phone communications, to extend the range of the aerial drone 20 from the wireless control 30.

In a further embodiment, a base station (not shown) is provided that the drone 20 can land on to recharge its battery 90. In another embodiment, the base station may control the drone 20 via a connection to the Internet so that the drone can be controlled from anywhere Wi-Fi is available. In an additional embodiment, the base station can operate the drone 20 to play fetch autonomously through pre-programmed flight patterns and times.

In some embodiments, as illustrated in FIG. 9, the wireless remote control 30 includes a wireless remote control enclosure 230 having an internal volume 231 therein for housing a remote control circuit 232 that includes at least a power source 234, a CPU 235, a memory 236, a wireless communication module 237, an antenna 238, and one or more user interfaces 239 in electrical communication with one another, all of which are adapted to transmit commands to, and receive data from, the drone 20. Alternate embodiments use a smart-phone 16 (FIG. 9) as the wireless remote control 30, the smart-phone being of the type that has at least an enclosure 160, a battery 161, a CPU 162, a memory 163, a touch display screen 164, at least one control speaker 166, at least one control microphone 167, and a wireless communication module (i.e., COM) 165 with antenna 238, in electrical communication with one another.

A software application 190 is adapted to be executed on the smart-phone 16, with the software application programmed to send the commands to the aerial drone 20. In embodiments of the system 10 wherein the drone 20 has at least one drone camera 180 and one or more drone microphones 170 (FIG. 4), the remote control 30 and/or the software application 190 is adapted to further receive and display video images from the aerial drone 20 on the touch display screen 164, and to receive and play the audio from the aerial drone on the at least one control speaker 166. In some embodiments, the commands may be issued by actuating mechanical or soft (displayed) controls of a user interface or by voice command in the case where the smart-phone 16 includes the control microphone 167.

As such, the wireless remote control 30 is used to command the aerial drone 20 to fly to a destination 18 (FIG. 1), and hover or land. When the person 15 or the pet 14 actuates the proximity switch 130, accelerometer 135, pressure switch 131, tube stop(s) 145, propeller stop extension(s) 134, and/or propeller brake 148, the motors 60 are deactivated by the control circuit 80. Preferably once the proximity switch 130, accelerometer 135, pressure switch 131, tube stop(s) 145, stop extension(s) 134, and/or propeller brake 148 is actuated, a restart countdown timer (not shown) and set for predetermined restart delay time, is started; after which delay time the motors can be actuated again by the wireless remote control 30, presumably when it is safe to do so.

One or more of the cameras 180 (FIGS. 1 and 4-6) are optionally located on the drone 20, preferably mounted with the drone enclosure 40, at least two of which have opposing fields of view 168 (FIG. 4). One or more of the drone microphones 170 are located on the drone 20 as well, again preferably mounted with the drone enclosure 40, whereby audio originating proximate the drone and video images from the one or more cameras 180 are stored by the control circuit 80 in the memory, and/or sent wirelessly to the wireless remote control 30 through the wireless communication module 140. An audio circuit 142 (FIG. 9) and drone speaker 175 (FIGS. 4 and 9) are optionally included on the drone 20 such that at least one audio signal received from the audio signal generator 141 of the wireless remote control 30 can be broadcast as the at least one sound from the drone.

In one embodiment, the at least one sound (i.e., voice commands or praise by the user) is transmitted through a control microphone 167 (FIG. 9) of the smart-phone 16 and to the audio signal generator 141. The audio signal generator 141 sends an at least one audio signal to the audio circuit 142 of the drone 20, which receives and processes the at least audio signal and forwards it to the drone speaker 175 (FIGS. 4 and 9) of the drone, which broadcasts the at least one sound from the drone. In another embodiment, the at least one sound is selected from a sound catalog stored within the memory 163 of the smart-phone 16 and actuated through the smart-phone's screen 164 by the user for transmission from the audio generator 141 to the audio circuit 142 and speaker 175 of the drone. The at least one sound within the catalog may comprise a selection of predetermined sounds, to include, without limitation, animal sounds, squeak-toy sounds, voice snippets, or any other sound. The at least one sound of the audio catalog may also originate from the control microphone 167.

In yet a further embodiment, the at least one sound broadcast through the drone speaker 175 of the drone 20 is activated by the same proximity switch 130, accelerometer 135, pressure switch 131, tube stop(s) 145, propeller brake 148 and/or propeller stop extension(s) 134 that deactivates the motors 60, with the sound generally selected from the user catalog of the smart-phone 16. The audio circuit 142 and drone speaker 175 of the drone 20 are thus in electrical communication with the control circuit 80 such that the control circuit activates a broadcast of the at least sound through the speaker when the proximity switch 130, accelerometer 135, pressure switch 131, tube stop(s) 145, propeller brake(s) 148 and/or propeller stop extension(s) 134 is actuated.

In some embodiments, one or more of the wireless RFID tag readers 132 are included with the proximity switch 130 such that the control circuit 80 can detect, based on RFID signal strength, the orientation of the drone enclosure 40 with respect to the RFID tag 133 (FIG. 1), thereby being able to orient the drone 20 such that one of the cameras 180 is always facing the RFID tag 133 and the pet 14 wearing it, whereby the video images sent back to the wireless remote control 30 will likely include the pet within the field of view 168 of that camera. A similar approach may be used with multiple antennas for the wireless communication module 140 in order to keep one of the cameras 180 focused on the person 15 controlling the drone 20.

The drone 20 may further include one or more LEDs 220 (FIGS. 4 and 9) or other lamps fixed with the drone enclosure 40 and in electrical communication with the control circuit 80. The LEDs 220 are oriented to illuminate an area 19 surrounding the aerial drone 20. Two associated commands receivable by the control circuit 80 are “lights on” and “lights off” commands.

In another embodiment illustrated in FIG. 6, the system 10 includes at least one supplemental stimuli feature 209 located on the drone 20. In one embodiment of the supplemental stimuli feature 209, a recess 210 is defined in the drone enclosure 40 and adapted for containing a treat or toy 17. The recess 210 may include a cover 211 that opens in concert with an electronic actuator 212 connected with the control circuit 80 such that the treat or toy 17 is prevented from falling away from the aerial drone 20 until the control circuit activates the electronic actuator to allow the cover to open; thus releasing the treat or toy. An associated command receivable by the control circuit in such an embodiment includes a “cover open” command.

In another embodiment of the supplemental stimuli feature 209, the drone enclosure 40 includes a connector (not shown) adapted for holding the treat or toy 17. The connector may include a release that opens in concert with an electronic actuator 212 connected with the control circuit 80, such that the toy or treat 17 is prevented from falling away from the aerial drone 20 until the control circuit 80 activates the electronic actuator 212 to allow the release to open, releasing the toy or treat 17. An associated command receivable by the control circuit in such an embodiment includes an “open release” command. In each of the foregoing embodiments, a spring (not shown) may be associated with the recess 210 or connector that spring biases the toy or treat 17 outwardly from the drone 20 such that the toy or treat is “ejected” from the drone when the cover 211 or release is opened by the electronic actuator 212.

In a further embodiment of the supplemental stimuli feature, a hook (not shown) is disposed on the lower side 42 of the drone enclosure 40 for allowing the person 15 to hand ribbons or other pet attractants from the drone 20. Alternately, an interference-fit aperture (not shown) disposed on the lower side 42 of the drone enclosure 40 cooperates with an elastomeric or plastic plug affixed to a rope or toy, whereby the dog 14 can jump up to grasp the rope or toy and pull it away from the drone 20, which maintains flight.

While this foregoing description and accompanying figures are illustrative of the present invention, other variations in structure and method are possible without departing from the invention's spirit and scope.

We claim:

1. An aerial drone system comprising:
an aerial drone comprising an enclosure defining an internal volume and enshrouding at least one motor fixed with a prop;
a control circuit located on the drone and having at least a power source, a CPU, a memory, at least one orientation sensor, at least one pressure switch, and a wireless communication module in electrical communication with one another, the control circuit in electrical communication with the at least one motor to control a motor speed and a motor direction, the control circuit deactivating the motors upon actuation of the at least one pressure switch, the at least one pressure switch operably associated with the drone enclosure to actuate when receiving a pressure there-from, the actuation of the pressure switch causing the at least one motor to deactivate; and
a wireless remote control adapted to communicate commands to the wireless communication module of the control circuit, the commands including at least commands for the aerial drone to rise, lower, move forward, move backward, turn left, turn right, turn on, and turn off; whereby the wireless remote control is used to command the aerial drone to fly to a destination and land, and when pressure switch is actuated and the motors are deactivated by the control circuit.

2. The aerial drone system of claim 1 further comprising an audio generator located on the remote control for generating at least one audio signal, a drone audio circuit located on the drone for receiving and processing the at least one audio signal, and a drone speaker in electrical communication with drone audio circuit for receiving the at least one audio signal from the drone audio circuit and broadcasting at least one sound from the aerial drone.

3. The aerial drone system of claim 2 wherein the drone audio circuit is in electrical communication with the control circuit, the audio circuit generating the at least one audio signal when the pressure switch is actuated.

4. The aerial drone system of claim 3 further comprising an audio catalog stored within a memory of the wireless remote control and in electrical communication with the audio circuit, the audio catalog storing the at least one sound for the audio signal generator.

5. The aerial drone system of claim 2 further comprising a microphone in electrical communication with the audio signal generator, the microphone receiving the at least one sound for the drone speaker.

6. The aerial drone system of claim 4 further comprising a microphone in electrical communication with the audio signal generator, the microphone receiving the at least one sound for the audio catalog.

7. The aerial drone system of claim 1 wherein the drone enclosure is comprised of upper and lower sides spring biased outwardly from one another, an inward movement of the upper and lowers sides towards one another generating the pressure received by the pressure switch.

8. The aerial drone system of claim 1 further comprising at least one stop extension operably associated with the enclosure and located proximal to the at least one propeller, the stop extension transmitting the pressure from the enclosure to the at least one propeller and causing the at least one motor to deactivate.

9. The aerial drone system of claim 1 further comprising at least one tube stop operably associated with the enclosure and located proximal to the at least one propeller, the tube stop transmitting the pressure from the enclosure to the at least one propeller and causing the at least one motor to deactivate.

10. The aerial drone system of claim 1 further comprising at least propeller brake operably associated with the enclosure and located proximal to the at least one propeller, the propeller brake transmitting the pressure from the enclosure to a ring and extension of the propeller and causing the at least one motor to deactivate.

11. The drone system of claim 1 further comprising a proximity switch in electrical communication with the control unit, the proximity switch comprising a RFID reader and RFID tag, the proximity switch actuated to cause the drone to hover in place at a predetermined vertical location when the RFID tag is within a predetermined distance from the RFID reader.

12. The drone system of claim 1 further comprising a proximity switch in electrical communication with the control unit, the proximity switch comprising a RFID reader and RFID tag, the proximity switch actuated to cause the drone to make a controlled landing when the RFID tag is within a predetermined distance from the RFID reader.

13. The aerial drone system of claim 1 further comprising at least one camera located on the drone, the at least one camera generating a video image, the video image stored in the memory of the control unit.

14. The aerial drone system of claim 1 further comprising at least one camera located on the drone, the at least one camera generating a video image, the video image transmitted to the remote control.

15. The aerial drone system of claim 14 further comprising a display screen and wherein the remote control is adapted to receive the video image from the at least one camera and display the video image the display screen.

16. An aerial drone system comprising:
an aerial drone comprising an enclosure defining an internal volume and enshrouding at least one motor fixed with a prop;
a control circuit located on the drone and having at least a power source, a CPU, a memory, at least one orientation sensor, at least one proximity switch, and a wireless communication module in electrical communication with one another, the control circuit in electrical communication with the at least one motor to control a motor speed and a motor direction, the control circuit deactivating the motors upon actuation of the at least one proximity switch, the proximity switch comprising a RFID reader and RFID tag, the proximity switch actuated when the RFID tag is within a predetermined distance from the RFID reader; and
a wireless remote control adapted to communicate commands to the wireless communication module of the control circuit, the commands including at least commands for the aerial drone to rise, lower, move forward, move backward, turn left, turn right, turn on, and turn off, whereby the wireless remote control is used to command the aerial drone to fly to a destination and land, and when proximity switch is actuated, the motors are deactivated by the control circuit.

17. The aerial drone system of claim 16 further comprising an audio generator located on the remote control for generating at least one audio signal, a drone audio circuit located on the drone for receiving and processing the at least one audio signal, and a drone speaker in electrical communication with drone audio circuit for receiving the at least one audio signal from the drone audio circuit and broadcasting at least one sound from the aerial drone.

18. The aerial drone system of claim 17 further comprising a microphone in electrical communication with the audio signal generator, the microphone receiving the at least one sound for the drone speaker.

19. The aerial drone system of claim 17 further comprising at least one stop extension operably associated with the enclosure and located proximal to the at least one propeller, the stop extension transmitting a pressure from the enclosure to the at least one propeller and causing the at least one motor to deactivate and the audio signal generator to generate the audio signal.

20. The aerial drone system of claim 17 further comprising at least one tube stop operably associated with the enclosure and located proximal to the at least one propeller, the tube stop transmitting a pressure from the enclosure to the at least one propeller and causing the at least one motor to deactivate and the audio signal generator to generate the audio signal.

21. The aerial drone system of claim 17 further comprising at least one propeller brake operably associated with the enclosure and located proximal to the at least one propeller, the propeller brake transmitting a pressure from the enclosure to a ring and extension of the propeller and causing the at least one motor to deactivate and the audio signal generator generate the audio signal.

22. The aerial drone system of claim 17 further comprising at least one pressure switch operably associated with the enclosure, the pressure switch receiving a pressure from the enclosure and causing the at least one motor to deactivate and the audio signal generator generate the audio signal.

23. The aerial drone system of claim 16 further comprising at least one camera located on the drone, the at least one camera generating a video image, the video image stored in the memory of the control unit.

24. The aerial drone system of claim 16 further comprising at least one camera located on the drone, the at least one camera generating a video image, the video image transmitted to the remote control.

25. The aerial drone system of claim 24 further comprising a display screen and wherein the remote control is adapted to receive the video image from the at least one camera and display the video image the display screen.

26. The aerial drone system of claim 1 further comprising a supplemental stimuli feature located on the aerial drone.

27. The aerial drone system of claim 16 further comprising a supplemental stimuli feature located on the aerial drone.
